(19) United States
(12) Patent Application Publication
(10) Pub. No.: US 2018/0300808 A1
(43) Pub. Date: Oct. 18, 2018

(54) System and method to allow mortgage consumers to obtain, store, access, and/or distribute their own data to multiple parties in a mortgage and/or real estate transaction

(71) Applicant: David Johnson, Catharpin, VA (US)

(72) Inventor: David Johnson, Catharpin, VA (US)

(21) Appl. No.: 15/486,827

(22) Filed: Apr. 13, 2017

(51) Int. Cl. G06Q 40/02

(52) U.S. Cl. CPC G06Q 40/025

(57) ABSTRACT

This is a system and method that allows mortgage consumers to obtain, store, access and/or distribute their authenticated documents required in underwriting their mortgage loans.

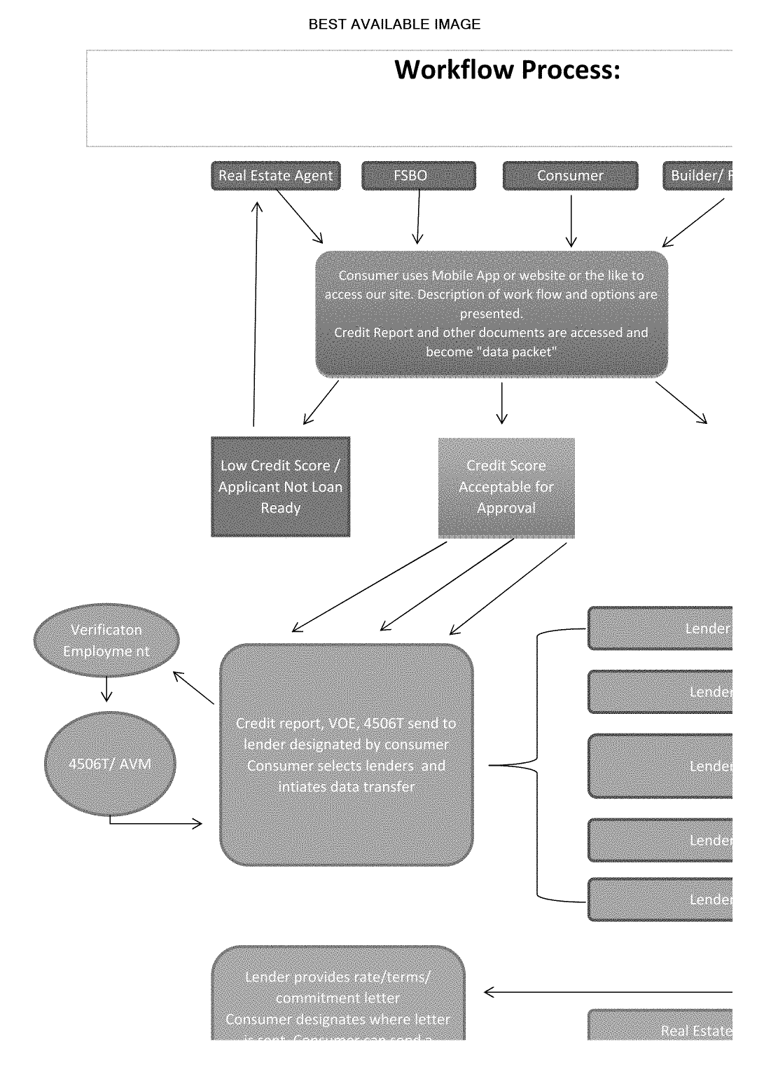

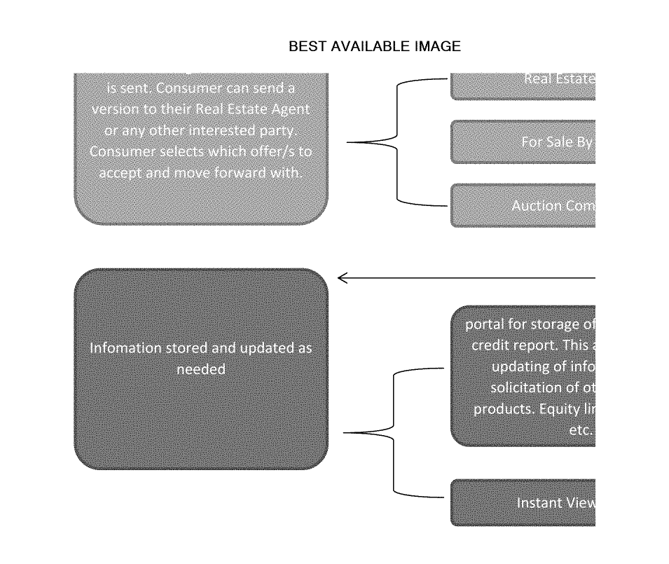

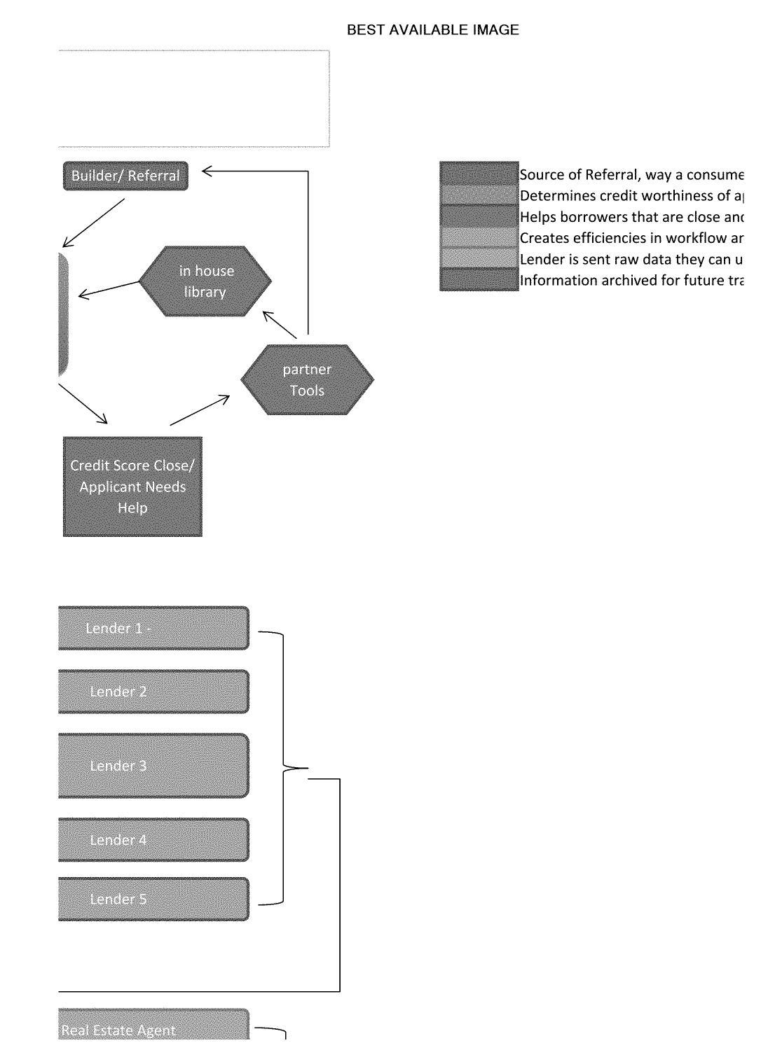

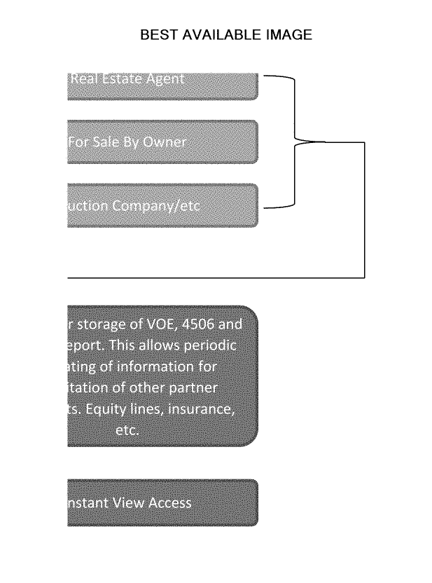

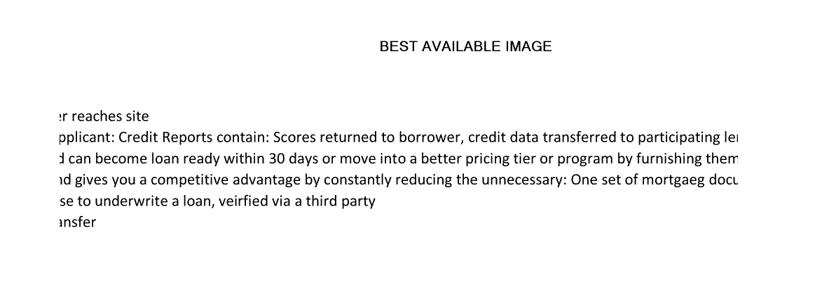

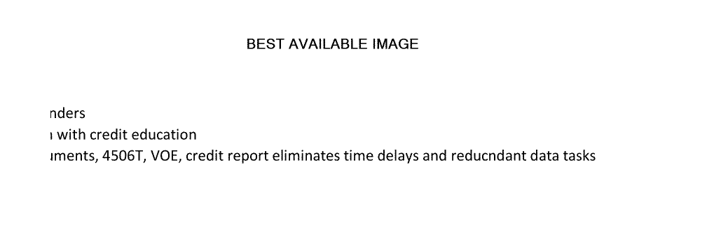

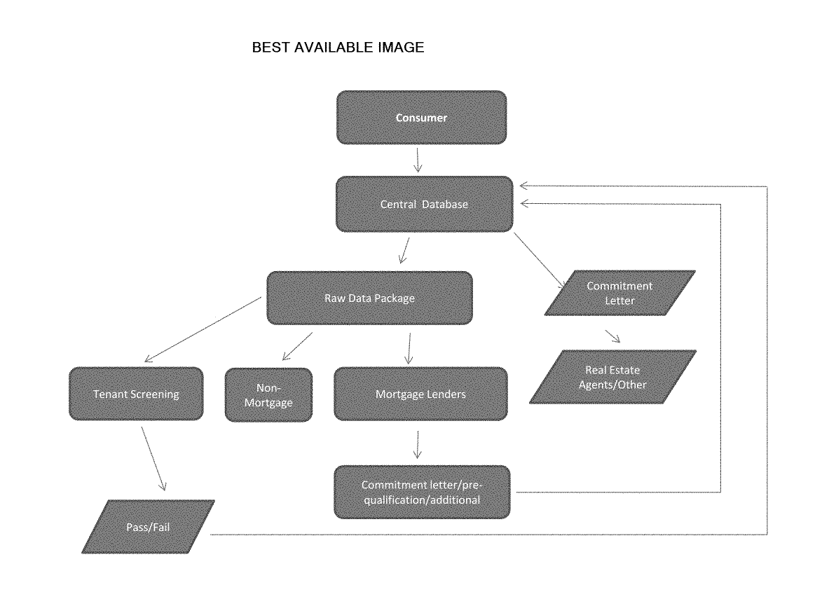

The documents include some or all of the following: (hereinafter referred to as ‘Data Package’)
Individual bureau credit reports, merged or unmerged
Reissuable and transferrable Fannie Mae/Freddie Mac credit report with mortgage credit scores from each bureau
Trended credit data
Verification of Employment report from The Work Number
Bank Statement Verification
Verification of Rent
Verification of Deposit
IRS tax transcripts
Fraud Information
Automated Valuation model for property value
SSA-89 Verification of social security number
Tax transcripts from TRS (4506T)
Any other documents required from lending parties

This Data Package, through the use of various technological platforms, can be obtained by or imported into a central database by the consumer. The consumer can select all or part of the Data Package to be distributed to whomever the consumer chooses.

Consumers will be more actively involved and take ownership in the loan process. They will be able to easily make inquiries of multiple vendors using the same information thereby saving themselves time and money. Sending inquires to multiple vendors will also allow consumers to shop around for the best rates and terms for their mortgage loans.

### BACKGROUND

Unfulfilled Needs: Under the current mortgage process, after a consumer makes a loan application, all of the items included in the Data Package are ordered by the lender or entity originating the loan or rental verification. If a consumer decides to change lenders, the new lender will have to obtain this information all over again. This creates additional expense and may penalize a borrower as credit scores are constantly changing. With new regulations in the mortgage industry (TRID, October 2015), not all data that is furnished on the credit report is useful, however with Trending data, this must be paid for each time a report is accessed. Lending guidelines require multiple reports to be accessed several times throughout the process. Under this process, a consumer is empowered to control the Data Package that is obtained and will access and pay only once for the data a particular lender needs to complete the loan underwriting.

Once working with a lender, there can be barriers for a consumer to switch lenders easily. For example, if a borrower obtains a credit score of 681 and the cut off for a program or rate tier is 680, by having a new credit report pulled a few days or weeks after an initial report, the scores could vary due to new updated balances and additional inquiries. Also, this expense of the credit reports and all reports are usually passed onto the consumer. A consumer may pay an application fee at Bank A and then switch to Bank B and have to pay another fee to Bank B. Thus, paying twice for the same data that could have been re-issued, or imported and published from Bank A to Bank B.

The traditional channel of how a consumer connects with a mortgage company may also change. Consumers will have the option to start their mortgage search directly with this process. The method and system defined by this application differs substantially from the current process because, this embodiment allows for business to start after the initial Data Package is obtained. This empowers the consumer to send the data package to multiple lenders and receive offers based on real underwriting data specific to the individual consumer. The consumer can then, through this method and system, obtain their own documents that are universally accepted and then facilitate the transfer of this data. By the consumer controlling this data, the data will only come from the source one time. This prevents multiple inquiries on the credit report, multiple charges for the same information while still giving the consumer the ability to shop around to various lenders. The mortgage loan process is very complex with many documents needed from many different vendors. This consolidates most necessary documents to one source saving time, money and providing security and competition.

This system will also allow any interested party to be part of the data sharing. As long as the consumer agrees to give access/permission, the parties will be able to share information specific and applicable to the real estate transaction. For example, a real estate agent that is a participant in this system and method will be able to direct a consumer to the site and the Realtor's preferred lenders will be a choice. The consumer may then select one, all or add other lenders to the portal so that their data packet may be sent and reviewed by as many lenders as the consumer chooses. Once terms/products/rates are returned, the consumer will then narrow the selection and alert all parties involved as to the next steps in moving forward.

1. The consumer will use a mobile application, website and/or like communication to: A. Create an account B. Log in C. Authenticate the user D. Generate data to be used in a mortgage underwriting capacity E. Import data/statements and/or order products deemed necessary for underwriting into a central database resulting in a ‘Data Package’ reviewable by the consumer and readily distributable to parties of the consumer's choosing.
The documents in the Data Package include some or all of the following:
Individual bureau credit reports, merged or unmerged ●Reissuable and transferrable Fannie Mae/Freddie Mac credit report with mortgage credit scores from each bureau ●Trended credit data ●Verification of Employment report from The Work Number ●Bank Statement Verification ●Verification of Rent ●Verification of Deposit ●IRS tax transcripts ●Fraud Information ●Automated Valuation model for property value ●SSA-89 Verification of social security number ●Tax transcripts from TRS (4506T) ●Any other documents required from lending parties

2. If there are errors in the Data Package, the system will allow the consumer to initiate directly, via electronic means, an on demand request to have the information reviewed and updated by originating sources. This request will initiate correction at both the creditor level and also extending to the national repository or any other data furnisher. Once the errors are resolved, the Data Package will be updated in the system.

3. Once the consumer populates the central database and reviews the results, s/he will choose where to send the Data Package. All reports in the Data Package ordered by the consumer will be deemed authentic when sending to selected parties. The Data Package can be sent (in part or in full) to multiple recipients grouped into 3 types of categories: mortgage lenders, tenant screening groups, and non-mortgage lenders/other (realtors, builders, private individuals, etc.).

4. The data obtained by the consumer in the Data Package will be in a format that allows for import and export to other parties and transfers ownership (at point of transfer) to the recipient at the consumer's request. For example, when the Data Package is sent to Banks A, B and C, the reports will be in the name of Banks A, B and C just as if the banks had ordered the reports themselves.

5. Once the Data Package is sent to a recipient it will be processed as follows:
A. Mortgage lenders will review the data and: Issue a commitment/prequalification letter that will be submitted and returned back to the central database. The consumer will review the letter and forward to whomever s/he chooses. b. Contact the consumer with questions/additional needs. The consumer will input this information into the central database and resubmit the Data Package.
B. Tenant screening groups will review the data and: a. Issue a ‘pass’ or ‘fail’ designation based on the data received. b. Contact the consumer with questions/additional needs. The consumer will input this information into the central database and resubmit the Data Package. C. Non-mortgage lenders will review the data for informational purposes and contact the consumer with additional questions.

6. After the loan is complete, the Data Package will be archived and updated periodically at the discretion of the consumer. This will provide access to and information for additional lending products, background checks and other applications that rely on data present in the Data Package. For example: 6 months after buying a house, a consumer could re-access the data to apply to refinance, obtain a second mortgage or a multitude of other products. The data baseline will also start to create a file for a consumer that can prove credit worthiness, job stability and lending history.
